(19) United States
(12) Patent Application Publication
(10) Pub. No.: US 2025/0061002 A1
(43) Pub. Date: Feb. 20, 2025

(54) COMPUTER-READABLE RECORDING MEDIUM STORING PIPELINE SET GENERATION PROGRAM, PIPELINE SET GENERATION METHOD, AND INFORMATION PROCESSING APPARATUS

(71) Applicant: Fujitsu Limited, Kawasaki-shi (JP)

(72) Inventor: Akira URA, Yokohama (JP)

(73) Assignee: Fujitsu Limited, Kawasaki-shi (JP)

(21) Appl. No.: 18/786,819

(22) Filed: Jul. 29, 2024

(30) Foreign Application Priority Data
Aug. 18, 2023 (JP) 2023-133478

(51) Int. Cl. G06F 9/50

(52) U.S. Cl. CPC G06F 9/5027

(57) ABSTRACT

A non-transitory computer-readable recording medium stores a pipeline set generation program for causing a computer to execute a process including: acquiring a first pipeline set of which each of pipelines includes a machine learning model, based on a plurality of tasks; generating a second pipeline set by adding specified components that correspond to each class of variables included in data of the plurality of tasks to each of the pipelines included in the first pipeline set; and acquiring evaluation values for each of the pipelines included in the second pipeline set, by executing the second pipeline set on the plurality of tasks; and generating a third pipeline set by selecting a plurality of the pipelines from the second pipeline set, based on the evaluation values.

### CROSS-REFERENCE TO RELATED APPLICATION

This application is based upon and claims the benefit of priority of the prior Japanese Patent Application No. 2023-133478, filed on Aug. 18, 2023, the entire contents of which are incorporated herein by reference.

### FIELD

The embodiments discussed herein are related to a pipeline set generation program, a pipeline set generation method, and an information processing apparatus.

### BACKGROUND

In the analysis using machine learning, machine learning algorithms such as a machine learning model to be used and a format of data to be input are different depending on data to be analyzed and purposes. In addition, as for the machine learning model, the prediction accuracy can be improved by appropriately tuning a hyperparameter. For such a reason, traditionally, in a case of conducting analysis using machine learning, data processing and shaping, feature engineering, hyperparameter optimization, design of a machine learning model, and the like have been performed by manual work of an expert of machine learning.

Japanese Laid-open Patent Publication No. 2022-87842, U.S. Patent Application Publication No. 2022/0051049, U.S. Patent Application Publication No. 2022/0207444, Japanese Laid-open Patent Publication No. 2022-44016, and Japanese Laid-open Patent Publication No. 2022-159132 are disclosed as related art.

### SUMMARY

According to an aspect of the embodiments, a non-transitory computer-readable recording medium stores a pipeline set generation program for causing a computer to execute a process including: acquiring a first pipeline set of which each of pipelines includes a machine learning model, based on a plurality of tasks; generating a second pipeline set by adding specified components that correspond to each class of variables included in data of the plurality of tasks to each of the pipelines included in the first pipeline set; and acquiring evaluation values for each of the pipelines included in the second pipeline set, by executing the second pipeline set on the plurality of tasks; and generating a third pipeline set by selecting a plurality of the pipelines from the second pipeline set, based on the evaluation values.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an information processing apparatus;

FIG. 2 is a diagram illustrating an example of a pipeline;

FIG. 3 is a diagram illustrating an example of suitable pipelines and degrees of deviation for each task;

FIG. 4 is a diagram illustrating an example of degrees of deviation of suitable pipelines for each task modified into complete pipelines;

FIG. 5 is a diagram illustrating an example of first selection of a pipeline to be included in a pipeline set;

FIG. 6 is a diagram illustrating an example of second selection of a pipeline to be included in the pipeline set;

FIG. 7 is a flowchart of a process of generating a pipeline set of robust pipelines by the information processing apparatus according to a first embodiment;

FIG. 8 is a flowchart of a default preprocessing component generation process by the information processing apparatus according to the first embodiment;

FIG. 9 is a diagram illustrating an example of a default preprocessing component generation method by an information processing apparatus according to a second embodiment;

FIG. 10 is a flowchart of a default preprocessing component generation process by the information processing apparatus according to the second embodiment; and

FIG. 11 is a hardware configuration diagram of a computer.

### DESCRIPTION OF EMBODIMENTS

In this manner, in order to appropriately conduct analysis using machine learning, advanced knowledge and techniques of data science are involved. Therefore, there has been a high hurdle for average users to use machine learning. Thus, research on automation of machine learning by auto machine learning (AutoML) that enables analysis using machine learning even without advanced techniques and knowledge has been in progress. In AutoML, data processing and shaping, feature engineering, generation of a machine learning model, and the like are automatically performed.

A series of processing flows including a plurality of preprocesses such as data processing and shaping, feature engineering, and hyperparameter adjustment, and prediction using data generated in each process and a machine learning model is collectively referred to as a “pipeline”. For example, the pipeline represents a series of processes in which a prediction process using a learner is performed after zero or more preprocesses. The pipeline includes hyperparameters in each process.

In addition, prediction target information obtained by adding designation of an objective variable, designation of an evaluation index, and the like to a dataset is referred to as a “task”. For example, AutoML is expected to determine a suitable pipeline for a specified task. However, the suitable pipeline here is a pipeline whose prediction accuracy falls within an acceptable range and is not an optimal pipeline in some cases.

Then, in AutoML, by holding a set of a small number of robust pipelines having a certain extent of prediction accuracy for many tasks, it becomes possible to quickly determine an appropriate pipeline for a specified task. Therefore, it can be said that holding a set of a small number of robust pipelines having a certain extent of prediction accuracy in many tasks as selection candidate pipelines is a promising method for achieving prediction performance that immediately falls within an acceptable range in AutoML.

As such a technique for holding a set of pipelines as selection candidates, there is a technique for executing AutoML for a large number of tasks and selecting, from among suitable pipelines for each task selected by AutoML, a pipeline set that is a subset of the suitable pipelines.

Other techniques for pipeline selection include techniques as follows. For example, a technique has been proposed in which a pipeline is selected for a new dataset, based on representative datasets in each class obtained by clustering a plurality of datasets, and a pipeline set is determined based on a rating value indicating performance of the selected pipeline. In addition, a technique has been proposed in which a pipeline set suited to predetermined data is determined, a preprocessed dataset of the predetermined data is generated, and a pipeline set is generated based on a hyperparameter set selected based on performance and a score obtained by applying the pipeline. In addition, a technique has been proposed in which each pipeline is ranked to determine a price of the pipeline, using a surrogate model, based on a user-designated index or a combination of the user-designated indices, and the price of each pipeline is determined in accordance with the rank. In addition, a technique has been proposed in which a first ranking set is generated using a first feature extracted from an existing machine learning project, a second ranking set is generated using a second feature generated based on the first feature, and a second ranking set having the highest rank is selected. In addition, a technique has been proposed in which a feature construction pipeline optimized for development from a feature construction pipeline constructed during training of a machine learning model is generated, a delay requirement of a data conversion operator is evaluated, and an optimized feature construction pipeline is created based on an impact evaluation for the delay.

However, there is a case where the pipeline generated by AutoML for a certain task does not include a preprocessing component for normally executing a process for another task. In the technique of selecting, from among suitable pipelines for each task, a pipeline set that is a subset of the suitable pipelines, a pipeline that does not include an appropriate preprocessing component is excluded in some cases because of a difficulty in executing another task. In practice, however, it is sometimes preferable to consider even such a pipeline that does not include an appropriate preprocessing component for another task, as a robust pipeline. Therefore, a pipeline set obtained as a subset of a set of suitable pipelines for each task is not necessarily sufficiently robust. Accordingly, it may be difficult to improve convenience of automation of machine learning.

In addition, even in the above-described other pipeline selection techniques, a pipeline lacking a preprocessing component for executing a predetermined task is not considered, and it is difficult to appropriately evaluate such a pipeline and incorporate such a pipeline into a pipeline set of robust pipelines.

The disclosed technique has been made in view of the above, and an object thereof is to provide a pipeline set generation program, a pipeline set generation method, and an information processing apparatus that improve convenience of automation of machine learning.

Hereinafter, embodiments of a pipeline set generation program, a pipeline set generation method, and an information processing apparatus disclosed in the present application will be described in detail with reference to the drawings. Note that the following embodiments do not limit the pipeline set generation program, the pipeline set generation method, and the information processing apparatus disclosed in the present application.

### First Embodiment

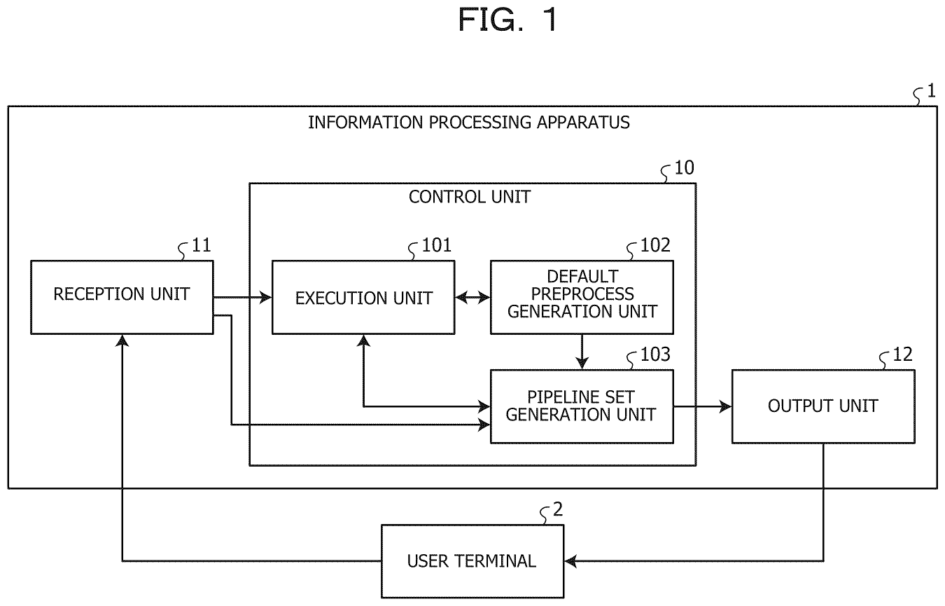

FIG. 1 is a block diagram of an information processing apparatus. The information processing apparatus 1 is coupled to a user terminal 2 that is an input source of data and an output destination of a processing result. The information processing apparatus 1 includes a control unit 10, a reception unit 11, and an output unit 12.

The reception unit 11 receives inputs of a task set and an AutoML program from the user terminal 2. The task set is a set of a plurality of tasks. The task is preferably a task similar to a task used when the user performs machine learning, using the AutoML program. The AutoML program is a program used by the user for analysis using machine learning. The AutoML program outputs a suitable pipeline, based on the input task. A suitable pipeline for a specified task is a pipeline having a higher prediction performance among the pipelines that can be generated for the specified task.

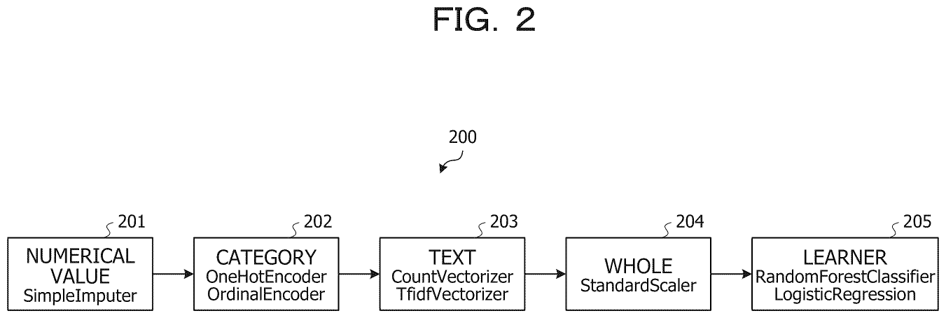

FIG. 2 is a diagram illustrating an example of a pipeline. The pipelines used in the following description will be described here with reference to FIG. 2.

A pipeline 200 includes components 201 to 205. The components 201 to 205 are programs that perform its respective processes such as conversion and prediction at each stage included in the pipeline 200. Commonly, data handled in each component of the pipeline is sometimes different. Thus, data handled in each component of the pipeline is referred to as a variable. In addition, information representing a variety of a variable such as what kind of information the variable has is referred to as a “variable type”. This variable is sometimes also referred to as a “column”. The components 201 to 205 handle different sorts of data from each other.

For example, the component 201 is a preprocess called SimpleImputer. The variable type used in the component 201 is “numerical value”. In addition, as the component 202, one of preprocesses is chosen from OneHotEncoder and OrdinalEncoder. The variable type used in the component 202 is “category”. The variables whose type is the category include, for example, gender and the like. Since the data input to the learner is a numerical value, the component 202 converts input data whose type is the category into a numerical value. As the component 203, one of preprocesses is chosen from CountVectorizer and a TfidfVectorizer. The variable type used in the component 203 is “text”. The component 204 converts input data whose type is the text into a numerical value. The variable type used in the component 204 is “whole”, which includes all the types used in the preceding components 201 to 203. The component 204 performs a process such as normalization of input data. The component 205 is a learner. The component 205 handles a variable whose type is the numerical value. The component 205 includes a machine learning model and performs prediction, using the included machine learning model.

The AutoML program generates, for example, a pipeline 200 including the preprocessing components according to each of variables corresponding to the components 201 to 204 and the learner corresponding to the component 205. The preprocessing components also include a component that performs a process on the whole data, such as the component 204. However, the pipeline generated by the AutoML program may not include a preprocessing component that performs a process on the whole data. The AutoML program selects optimal combinations from among a plurality of preprocessing components and hyperparameters, as preprocessing components for each variable type.

Returning to FIG. 1, the description will be continued. The reception unit 11 outputs the received task set and AutoML program to an execution unit 101 of the control unit 10.

Here, in the present embodiment, in a case where a suitable pipeline obtained by AutoML for a certain specified task is known, the prediction performance of the target pipeline as an evaluation target is represented by the degree of deviation corresponding to a difference from the prediction performance of the suitable pipeline. For example, the degree of deviation is an index representing how much the prediction performance for a specified task when the target pipeline is used deviates from the prediction performance for the same specified task when the suitable pipeline is used. For example, the degree of deviation is represented as “degree of deviation=(prediction performance of suitable pipeline)−(prediction performance of target pipeline)” when represented by a formula. The degree of deviation is sometimes also referred to as “regret”.

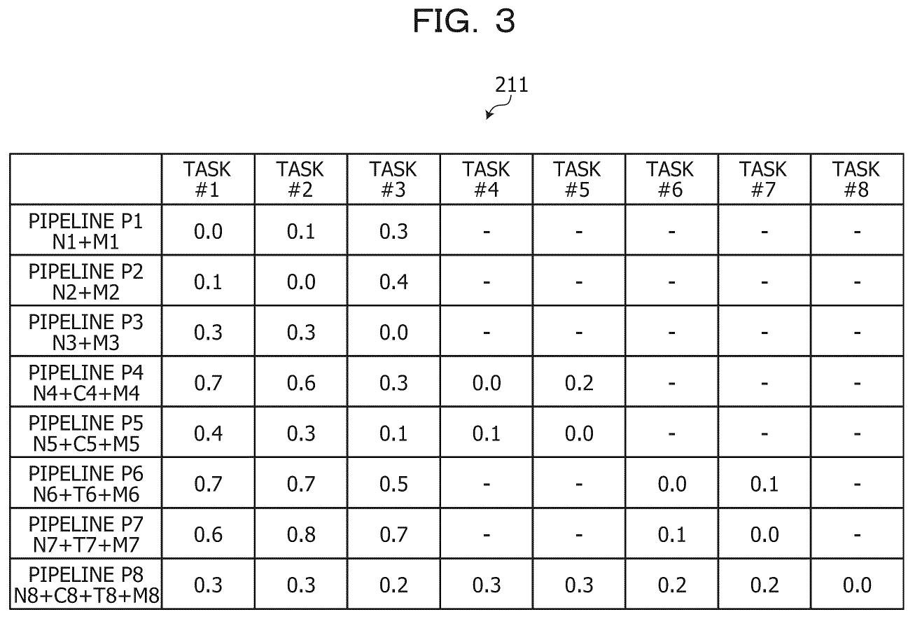

FIG. 3 is a diagram illustrating an example of suitable pipelines and degrees of deviation for each task. Here, as illustrated in Table 211 in FIG. 3, a case where there are tasks #1 to #8 and pipelines P1 to P8 are each a suitable pipeline for one of the tasks #1 to #8 will be described.

The task #1 is a task having data whose variable type is a numerical value. Then, the pipeline P1 is a suitable pipeline for the task #1 and includes a preprocessing component N1 for data whose variable type is a numerical value and a machine learning model M1 that is a learner. The added symbols listed on the lower side of each of the pipelines P1 to P8 in Table 211 when viewed toward the paper surface represent the preprocessing components and the machine learning models included in each of the pipelines P1 to P8.

In addition, the task #2 is a task having data whose variable type is a numerical value. Then, the pipeline P2 is a suitable pipeline for the task #2 and includes a preprocessing component N2 for data whose variable type is a numerical value and a machine learning model M2. The task #3 is a task having data whose variable type is a numerical value. Then, the pipeline P3 is a suitable pipeline for the task #3 and includes a preprocessing component N3 for data whose variable type is a numerical value and a machine learning model M3.

The task #4 is a task having data whose variable type is a numerical value and data whose variable type is a category. Then, the pipeline P4 is a suitable pipeline for the task #4 and includes a preprocessing component N4 for data whose variable type is a numerical value, a preprocessing component C4 for data whose variable type is a category, and a machine learning model M4.

The task #5 is a task having data whose variable type is a numerical value and data whose variable type is a category. Then, the pipeline P5 is a suitable pipeline for the task #5 and includes a preprocessing component N5 for data whose variable type is a numerical value, a preprocessing component C5 for data whose variable type is a category, and a machine learning model M5.

The task #6 is a task having data whose variable type is a numerical value and data whose variable type is text. Then, the pipeline P6 is a suitable pipeline for the task #6 and includes a preprocessing component N6 for data whose variable type is a numerical value, a preprocessing component T6 for data whose variable type is text, and a machine learning model M6.

The task #7 is a task having data whose variable type is a numerical value and data whose variable type is text. Then, the pipeline P7 is a suitable pipeline for the task #7 and includes a preprocessing component N7 for data whose variable type is a numerical value, a preprocessing component T7 for data whose variable type is text, and a machine learning model M7.

The task #8 is a task having data whose variable type is a numerical value, data whose variable type is a category, and data whose variable type is text. Then, the pipeline P8 is a suitable pipeline for the task #8. The pipeline P8 includes a preprocessing component N8 for data whose variable type is a numerical value, a preprocessing component C8 for data whose variable type is a category, a preprocessing component T8 for data whose variable type is text, and a machine learning model M8.

As illustrated in Table 211, the degree of deviation of each of the pipelines P1 to P8 can be calculated for each of the tasks #1 to #8. However, since the pipelines P1 to P3 do not include preprocessing components for data whose variable type is a category and data whose variable type is text, it is difficult to predict the tasks #4 to #8, and the degree of deviation for each of the tasks #4 to #8 is not calculated. In addition, since the pipelines P4 and P5 do not include a preprocessing component for data whose variable type is text, it is difficult to predict the tasks #6 to #8, and the degree of deviation for each of the tasks #6 to #8 is not calculated. In addition, since the pipelines P6 and P7 do not include a preprocessing component for data whose variable type is a category, it is difficult to predict the tasks #4, #5, and #8, and the degree of deviation for each of the tasks #4, #5, and #8 is not calculated.

Returning to FIG. 1, the description will be continued. The reception unit 11 also receives, from the user terminal 2, information on a desired degree of deviation that is a desired value of the degree of deviation for each task. Here, the desired degree of deviation may be different or the same for each task. Then, the reception unit 11 outputs the received desired degree of deviation to a pipeline set generation unit 103 of the control unit 10. This desired degree of deviation may be input beforehand.

The control unit 10 generates a suitable pipeline for each task, based on a plurality of tasks, and adds a preprocess to each pipeline such that all variables included in each task can be processed. Then, the control unit 10 executes, on each task, a pipeline to which a preprocess has been added and generates a pipeline set of robust pipelines from the obtained degrees of deviation. Here, a set of suitable pipelines for each task corresponds to an example of a “first pipeline set”. In addition, a set of pipelines obtained by adding a preprocess to each of suitable pipelines for each task corresponds to an example of a second pipeline set. In addition, the degree of deviation obtained by executing, on each task, a pipeline to which a preprocess has been added corresponds to an example of an “evaluation value”. Furthermore, a pipeline set of robust pipelines generated based on the degrees of deviation corresponds to an example of a “third pipeline set”.

For example, the control unit 10 acquires the first pipeline set of which each pipeline includes a machine learning model, based on a plurality of tasks. Next, the control unit 10 generates the second pipeline set by adding, to each pipeline included in the first pipeline set, specified components corresponding to each class of variables included in data of the plurality of tasks. Next, the control unit 10 acquires the evaluation value of each pipeline included in the second pipeline set, by executing the second pipeline set on the plurality of tasks. Next, the control unit 10 generates the third pipeline set by selecting a plurality of pipelines from the second pipeline set, based on the evaluation values.

Details of the control unit 10 will be described below. As illustrated in FIG. 1, the control unit 10 includes the execution unit 101, a default preprocess generation unit 102, and the pipeline set generation unit 103.

The execution unit 101 accepts inputs of a task set and the AutoML program from the reception unit 11. Next, the execution unit 101 executes the AutoML program on each task included in the task set. Then, the execution unit 101 acquires suitable pipelines for each task output as execution results of the AutoML program. The execution unit 101 then outputs the task set and the acquired suitable pipelines for each task to the default preprocess generation unit 102 and the pipeline set generation unit 103.

The default preprocess generation unit 102 acquires the task set and the suitable pipelines for each task from the execution unit 101. Here, the default preprocess generation unit 102 has in advance information on types of variables to be input to each component in each task. Then, the default preprocess generation unit 102 selects one variable type from among variable types used in each task.

Next, the default preprocess generation unit 102 acquires, from each pipeline, a preprocessing component that performs a process with data of the selected variable type as an input. Hereinafter, the preprocessing component that performs a process with data of the selected variable type as an input will be referred to as a “preprocessing component for the selected variable type”. Here, the preprocessing component for the selected variable type is different for each pipeline in some cases or the same for each pipeline in other cases. Thus, the default preprocess generation unit 102 calculates each of appearance frequencies of the same preprocessing component among the preprocessing components for the selected variable type in all pipelines.

Next, the default preprocess generation unit 102 extracts a preprocessing component for the selected variable type having a highest appearance frequency. Then, the default preprocess generation unit 102 assigns the extracted preprocessing component as a default preprocessing component for the selected variable type.

The default preprocess generation unit 102 performs the above-described process on all the variable types included in each task and determines the default preprocessing components for all the variable types. For example, in a case where there are three types of “numerical value”, “category”, and “character string” as the variable types included in each task, the default preprocess generation unit 102 determines the default preprocessing components for each of “numerical value”, “category”, and “character string”. However, the default preprocess generation unit 102 may omit determination of the default preprocessing component for a preprocessing component for a variable type included in all the tasks. Then, the default preprocess generation unit 102 outputs, to the pipeline set generation unit 103, information on the default preprocessing components for each of the variable types included in each task.

This default preprocessing component corresponds to an example of a “specified component”. For example, the default preprocess generation unit 102 selects the specified component, based on the components included in the first pipeline set. For example, the default preprocess generation unit 102 selects, for a specified pipeline included in the first pipeline set, a component that is not included in the specified pipeline among the components included in the first pipeline set, as a specified component for the specified pipeline. In addition, for a specified class of the variables, in a case where there is a plurality of varieties of components not included in the specified pipeline among the components included in the first pipeline set, the default preprocess generation unit 102 performs the following process. For example, the default preprocess generation unit 102 selects a specified component corresponding to the specified class of the variables, based on the appearance frequency of each variety in the first pipeline set.

Here, a case where there are the tasks #1 to #8 and there are the pipelines P1 to P8 illustrated in Table 211 in FIG. 3 will be described as an example. In addition, Table 211 illustrates the degrees of deviation of the respective combinations of the tasks #1 to #8 and the pipelines P1 to P8.

For example, in a case where the preprocessing component C4 and the preprocessing component C5 are the same preprocessing component, the default preprocess generation unit 102 selects a default preprocessing component for data whose variable type is a category as follows. Since the preprocessing component C4 appears twice in the pipelines P4 and P5 and the preprocessing component C8 appears once in the pipeline P8, the default preprocess generation unit 102 selects the pipeline P4 having a higher appearance frequency as a default preprocessing component for data whose variable type is a category. The default preprocess generation unit 102 similarly determines a default preprocessing component for data whose variable type is a numerical value and a default preprocessing component for data whose variable type is text.

The pipeline set generation unit 103 acquires the task set and the suitable pipelines for each task from the execution unit 101. In addition, the pipeline set generation unit 103 accepts an input of information on the default preprocessing components for each variable type from the default preprocess generation unit 102. In addition, the pipeline set generation unit 103 accepts an input of the desired degree of deviation from the reception unit 11.

Next, the pipeline set generation unit 103 selects one pipeline from the suitable pipelines for each task and verifies whether or not there is a preprocessing component that exists in the other pipelines but does not exist in the selected pipeline. Here, a preprocessing component that exists in the other pipelines but does not exist in the selected pipeline will be referred to as a “lacking preprocessing component”. In a case where a lacking preprocessing component exists in the selected pipeline, the pipeline set generation unit 103 performs complementation in an inter-lack process, using a default preprocessing component of a variable type to be processed by the preprocessing component corresponding to the lacking preprocessing component. Here, a pipeline in which all lacking preprocessing components are retained, for example, a pipeline having all the preprocessing components for the variable types used in each task, will be referred to as a “complete pipeline”. The pipeline set generation unit 103 modifies all the suitable pipelines for each task into complete pipelines having the same preprocessing components.

Next, the pipeline set generation unit 103 transmits the suitable pipelines for each task modified into the complete pipelines to the execution unit 101 and causes the execution unit 101 to execute processing by each pipeline for each task. Thereafter, the pipeline set generation unit 103 acquires an execution result from the execution unit 101. Next, the pipeline set generation unit 103 calculates the degrees of deviation for each task of the suitable pipelines for each task modified into the complete pipelines, using the acquired execution results.

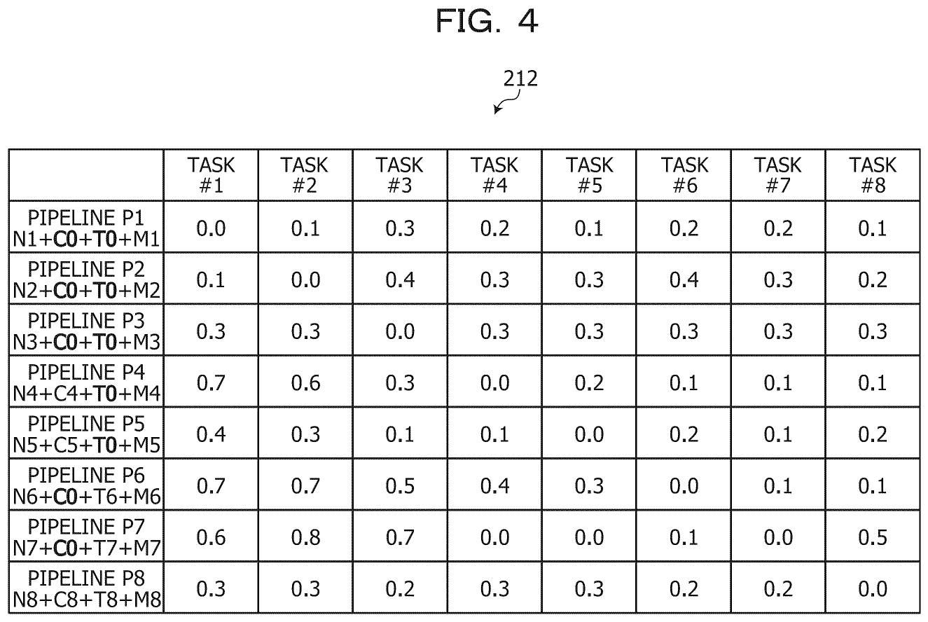

FIG. 4 is a diagram illustrating an example of degrees of deviation of the suitable pipelines for each task modified into the complete pipelines. For example, the pipeline set generation unit 103 modifies each of the pipelines P1 to P8 illustrated in Table 211 in FIG. 3 into a complete pipeline. Here, the pipeline set generation unit 103 assigns the default preprocessing component for data whose variable type is a category, as a preprocessing component CO, and assigns the default preprocessing component for data whose variable type is text, as a preprocessing component TO.

The pipeline set generation unit 103 adds the preprocessing components CO and T0 to each of the pipelines P1 to P3 to form complete pipelines. In addition, the pipeline set generation unit 103 adds the preprocessing component T0 to the pipelines P4 and P5 to form complete pipelines. In addition, the pipeline set generation unit 103 adds the preprocessing components NO and CO to the pipeline P6 to form a complete pipeline. In addition, the pipeline set generation unit 103 adds the preprocessing component CO to the pipeline P7 to form a complete pipeline.

Here, in Table 211 in FIG. 3, since there are lacking preprocessing components and there are tasks that are difficult to execute in the pipelines P1 to P7, the executable pipeline P8 constitutes a pipeline set of robust pipelines. In these circumstances, as illustrated in Table 212 in FIG. 4, by modifying all the pipelines P1 to P8 into complete pipelines, the pipeline set generation unit 103 can calculate the degree of deviation of each of the pipelines P1 to P8 for all the tasks #1 to #8. Accordingly, the pipeline set generation unit 103 can include any of the pipelines P1 to P8 in the pipeline set.

Next, the pipeline set generation unit 103 calculates an error representing a difference between the degree of deviation and the desired degree of deviation for each combination of the task and the pipeline. However, the lowest value of the error is assumed to be zero. For example, the error can be represented as “error=max(degree of deviation−desired degree of deviation, 0)” when represented by a formula. In this formula, “max” denotes a function that selects a larger value of the two elements. The error is sometimes also referred to as “loss”. Note that, in a case where the desired degree of deviation is assumed to be zero, for example, in a case where the desired degree of deviation is reached in a case where the suitable pipeline has undeviated prediction performance, the error matches the degree of deviation.

Next, the pipeline set generation unit 103 initializes the pipeline set with an empty set. Then, the pipeline set generation unit 103 repeats the following process to generate a pipeline set of robust pipelines. For example, the pipeline set generation unit 103 tentatively adds, to the pipeline set, one of the suitable pipelines for each task that is not included in the pipeline set, for each pipeline. Then, for each of the pipeline sets to which different pipelines have been tentatively added, the pipeline set generation unit 103 adds up the minimum value of the errors for each task included in the pipeline set for all the tasks to calculate an error sum. Then, the pipeline set generation unit 103 generates a new pipeline set by actually adding, to the pipeline set, the tentatively added pipeline when the error sum is minimized.

The pipeline set generation unit 103 repeats addition of the pipeline to the pipeline set until a predefined pipeline set generation end condition is satisfied. The generation end condition is set based on, for example, the upper limit of the number of pipelines included in the pipeline set, the elapsed time, or the like. Then, the pipeline set generation unit 103 outputs the pipeline set at the time point when the generation end condition is satisfied to the output unit 12 as a pipeline set of robust pipelines.

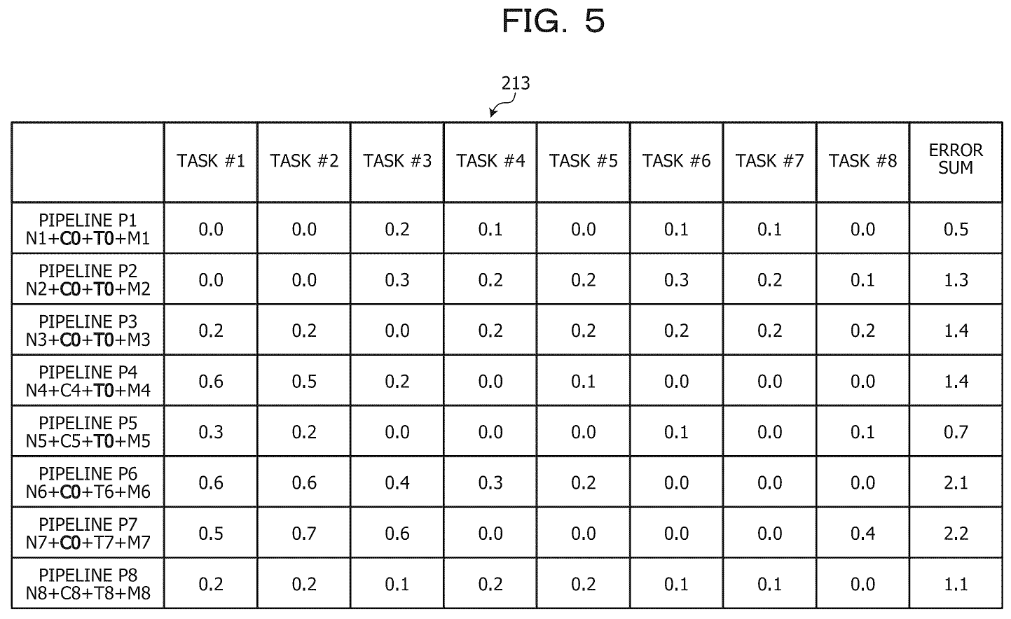

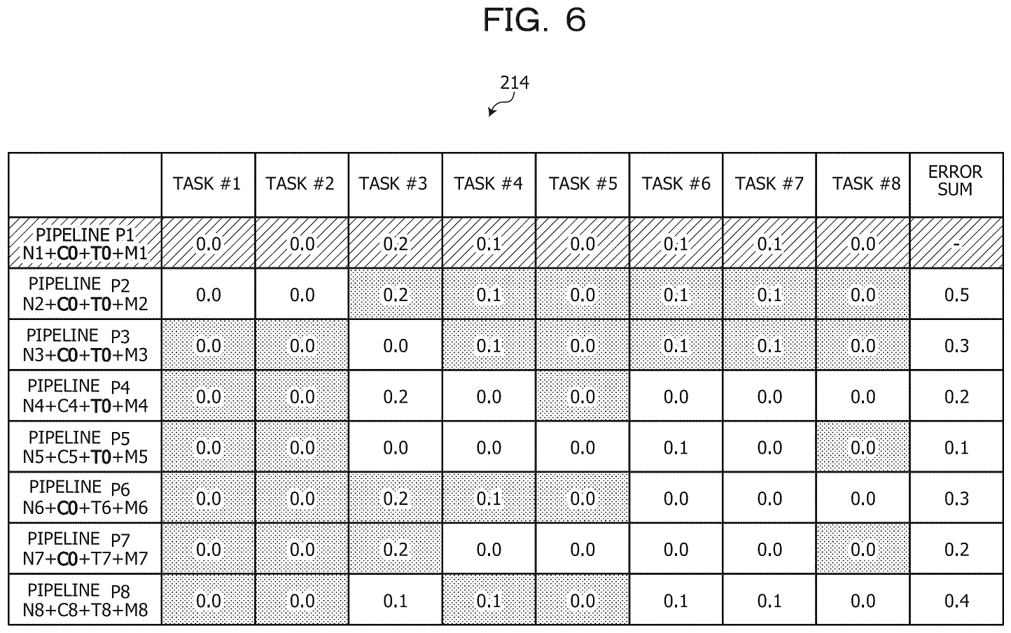

FIG. 5 is a diagram illustrating an example of first selection of a pipeline to be included in the pipeline set. In addition, FIG. 6 is a diagram illustrating an example of second selection of a pipeline to be included in the pipeline set. Here, an example of generation of a pipeline set by the pipeline set generation unit 103 will be described with reference to FIGS. 5 and 6. Here, a case where the desired degree of deviation is 0.1 will be described.

The pipeline set generation unit 103 subtracts the desired degree of deviation from the degree of deviation of each of the combinations of the pipelines P1 to P8 and the tasks #1 to #8 and calculates an error of each combination as illustrated in Table 213 in FIG. 5.

In a state in which the pipeline set is an empty set, the minimum values of the errors for each of the tasks #1 to #8 included in the pipeline sets when the pipeline set generation unit 103 tentatively adds one of the pipelines P1 to P8 to the pipeline set for each of the pipelines P1 to P8 matches the errors of the respective pipelines P1 to P8. Thus, for each of the pipelines P1 to P8, the pipeline set generation unit 103 simply obtains the sum of its individual errors and calculates the error sum. In this case, as illustrated in Table 213 in FIG. 5, since the error sum of the pipeline P1 is 0.5 and is the smallest, the pipeline set generation unit 103 adds the pipeline P1 to the pipeline set.

Next, the pipeline set generation unit 103 adds one of the pipelines P2 to P8 to the pipeline set including the pipeline P1 for each of the pipelines P2 to P8 and obtains the minimum values of the errors in each of the tasks #1 to #8. Table 214 illustrates the minimum values of the errors for each of the tasks #1 to #4 when each of the pipelines P2 to P8 is added to the pipeline set including the pipeline P1. The pipeline P1 in Table 214 is already included in the pipeline set and is excluded from the pipeline to be added next. Then, in the grayed out portions in Table 214, the errors of the pipeline P1 are written because the errors of the pipeline P1 are the minimum values. In the other portions, since the errors of the added pipelines P2 to P8 are smaller than the errors of the pipeline P1, the errors of the pipelines P2 to P8 are written.

The pipeline set generation unit 103 adds up the errors in Table 214 to obtain the error sum for each of cases where each of the pipelines P2 to P8 is added. In this case, since the error sum when the pipeline P5 is added is 0.1 and is the smallest, the pipeline set generation unit 103 adds the pipeline P5 to the pipeline set. For example, the pipeline set includes the pipelines P1 and P5.

Here, the suitable pipelines for each task correspond to an example of “reference pipelines”. For example, the pipeline set generation unit 103 acquires differences between the prediction accuracy of the reference pipelines and the prediction accuracy of each pipeline included in the second pipeline set, as the evaluation values for each task of the plurality of tasks.

Returning to FIG. 1, the description will be continued. The output unit 12 accepts an input of the pipeline set of robust pipelines from the pipeline set generation unit 103. Then, the output unit 12 transmits the acquired pipeline set to the user terminal 2 and notifies the user of the pipeline set. The user may acquire a pipeline having a certain extent of prediction performance in a short time, by executing the AutoML program, using the pipeline set of robust pipelines notified by the information processing apparatus 1.

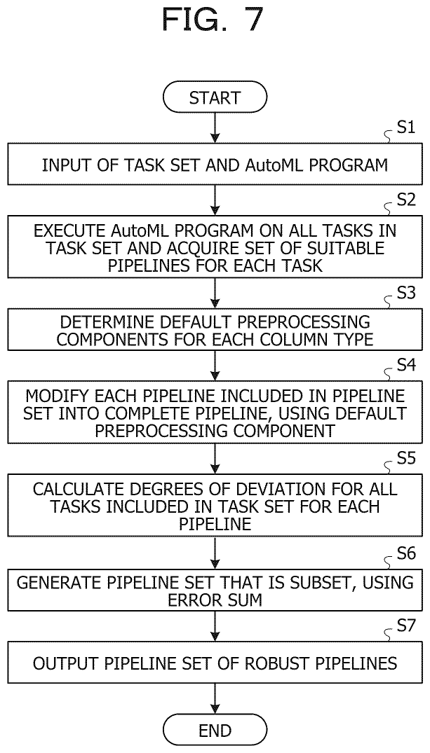

FIG. 7 is a flowchart of a process of generating a pipeline set of robust pipelines by the information processing apparatus according to the first embodiment. Next, a flow of the process of generating a pipeline set of robust pipelines by the information processing apparatus 1 according to the present embodiment will be described with reference to FIG. 7.

The user inputs a task set and the AutoML program to the information processing apparatus 1, using the user terminal 2 (step S1).

The reception unit 11 receives the task set and the AutoML program input from the user terminal 2 and outputs the received task set and AutoML program to the execution unit 101. The execution unit 101 executes AutoML on all the tasks of the task set and acquires a set of suitable pipelines for each task (step S2).

The default preprocess generation unit 102 determines default preprocessing components for all variable types included in each task (step S3).

The pipeline set generation unit 103 complements the lacking preprocessing component of a pipeline having the lacking preprocessing component among the suitable pipelines, with the default preprocessing component, and modifies each pipeline included in the pipeline set into a complete pipeline (step S4).

The pipeline set generation unit 103 causes the execution unit 101 to execute each suitable pipeline adapted into a complete pipeline, on each task, and acquires an execution result. Then, the pipeline set generation unit 103 calculates the degrees of deviation for all the tasks included in the task set for each suitable pipeline adapted into a complete pipeline (step S5).

Next, the pipeline set generation unit 103 adds one pipeline not included in the pipeline set among the suitable pipelines to the pipeline set, for each pipeline, and adds up the minimum values of the errors included in the pipeline set for all the tasks to calculate the error sum. Then, the pipeline set generation unit 103 generates a pipeline set by repeating addition of a pipeline having a smallest error sum to the pipeline set (step S6).

The pipeline set generation unit 103 outputs the generated pipeline set to the output unit 12. The output unit 12 transmits the pipeline set of robust pipelines input from the pipeline set generation unit 103 to the user terminal 2 (step S7).

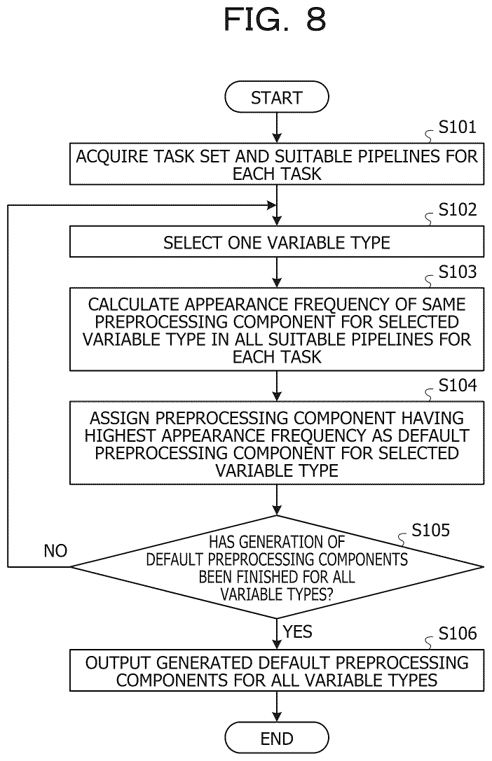

FIG. 8 is a flowchart of a default preprocessing component generation process by the information processing apparatus according to the first embodiment. Each process illustrated in the flowchart in FIG. 8 corresponds to an example of the process executed in step S3 in FIG. 7. Next, a flow of the default preprocessing component generation process by the information processing apparatus 1 according to the present embodiment will be described with reference to FIG. 8.

The default preprocess generation unit 102 acquires the task set and the suitable pipelines for each task from the execution unit 101 (step S101).

The default preprocess generation unit 102 selects one variable type from among variable types used in each task (step S102).

Next, the default preprocess generation unit 102 acquires, from each pipeline, a preprocessing component that performs a process with data of the selected variable type as an input. Then, the default preprocess generation unit 102 calculates the appearance frequency of the same preprocessing component among the preprocessing components for the selected variable type in all the suitable pipelines for each task (step S103).

Next, the default preprocess generation unit 102 extracts a preprocessing component having a highest appearance frequency among the preprocessing components for the selected variable type. Then, the default preprocess generation unit 102 assigns the extracted preprocessing component as a default preprocessing component for the selected variable type (step S104).

Next, the default preprocess generation unit 102 verifies whether or not generation of default preprocessing components has been finished for all the variable types (step S105). In a case where a variable type for which the default preprocessing component has not been generated remains (step S105: No), the default preprocess generation unit 102 returns to step S102.

Meanwhile, in a case where generation of the default preprocessing components has been finished for all the variable types (step S105: Yes), the default preprocess generation unit 102 outputs all the generated default preprocessing components to the pipeline set generation unit 103 (step S106).

As described above, the information processing apparatus according to the present embodiment determines, for all variable types included in each of tasks in a task set, a default preprocessing component capable of processing data having the relevant variable type. Then, the lacking preprocessing component of each of the suitable pipelines for each task generated by AutoML is complemented with the default preprocessing component, and all of the suitable pipelines for each task are modified into complete pipelines. This allows each of the suitable pipelines for each task to process all the tasks. Thus, the information processing apparatus according to the present embodiment generates a pipeline set of robust pipelines, using the suitable pipelines for each task modified into complete pipelines.

This allows all the suitable pipelines for each task to be used to generate a pipeline set of robust pipelines and enables to generate a pipeline set of pipelines with high robustness. By executing automation of machine learning using the pipeline set of pipelines with high robustness thus obtained, it may become easy to determine a suitable pipeline, and convenience of automation of machine learning may be improved.

In addition, since a preprocessing component having a higher appearance frequency can be deemed as a preprocessing component having higher versatility, robustness may be further improved by assigning a preprocessing component having a high appearance frequency as a default preprocessing component. For example, in a case where the number of varieties of preprocessing components for the same variable type is small, a difference in appearance frequency is superior to the level of versatility, and by assigning a preprocessing component having a high appearance frequency as a default preprocessing component, robustness may be enhanced. For example, the case where the number of varieties of preprocessing components for the same variable type is small is a case where the number of varieties is half or less of the total number of tasks, or the like.

### Second Embodiment

Next, a second embodiment will be described. An information processing apparatus 1 according to the present embodiment is also illustrated in the block diagram in FIG. 1. The information processing apparatus 1 according to the present embodiment is different from the information processing apparatus 1 of the first embodiment in a method of generating a default preprocessing component by a default preprocess generation unit 102. Hereinafter, a method for generating a default preprocessing component by the default preprocess generation unit 102 according to the present embodiment will be described in detail. In the following explanation, description of operations of respective units similar to those of the first embodiment will be omitted.

The default preprocess generation unit 102 extracts all variable types included in each task in a task set. Next, the default preprocess generation unit 102 performs the following process on all the extracted variable types for each of the variable types, thereby generating default preprocessing components for each of the variable types.

The default preprocess generation unit 102 extracts all preprocessing components for a target variable type among preprocessing components included in the suitable pipelines for each task. In addition, the default preprocess generation unit 102 extracts a pipeline having a preprocessing component for the target variable type from among the suitable pipelines for each task.

Next, for each of the extracted pipelines, the default preprocess generation unit 102 replaces the preprocessing component for the target variable type with another preprocessing component for the same variable type included in another pipeline. Next, the default preprocess generation unit 102 causes an execution unit 101 to execute processing by the pipeline after the replacement of the preprocessing component on the task that was regarded as suitable before the replacement of the preprocessing component. Then, the default preprocess generation unit 102 acquires an execution result by the execution unit 101 to calculate an error before the preprocessing component replacement and an error after the preprocessing component replacement and calculates prediction accuracy degradation, which is the amount of increase in error, due to the replacement of the preprocessing component. The default preprocess generation unit 102 verifies that the prediction accuracy degrades less as the increase in error is smaller.

Then, the default preprocess generation unit 102 assigns a preprocessing component having a smallest maximum value of degradation of prediction accuracy when the preprocessing component is replaced, as a default preprocessing component. It can be said that as the maximum value of the degradation of prediction accuracy is smaller, an exceptionally large degradation of the prediction accuracy may be suppressed for more tasks, and the robustness may be further improved.

However, the default preprocess generation unit 102 can also use another default preprocessing component selection method as long as the selection method can suppress degradation of prediction accuracy for many tasks. For example, the default preprocess generation unit 102 may calculate the sum of degradation of prediction accuracy when the preprocessing component is replaced, for each preprocessing component, and assign a preprocessing component that minimizes the calculated sum, as the default preprocessing component. It can be said that as the sum of degradation of prediction accuracy is smaller, degradation of prediction accuracy may be suppressed on average for any task, and the robustness may be further improved.

The default preprocess generation unit 102 generates default preprocessing components for all the variable types by the method described above. Then, the default preprocess generation unit 102 outputs the generated default preprocessing components for all the variable types to a pipeline set generation unit 103.

For example, for a specified class of the variables, in a case where there is a plurality of varieties of components not included in the specified pipeline among the components included in the first pipeline set, the default preprocess generation unit 102 executes the following process. The default preprocess generation unit 102 selects a specified component corresponding to the specified class of the variables, based on degradation of prediction accuracy by a machine learning model of each pipeline included in the first pipeline set when components of different varieties are replaced in the first pipeline set.

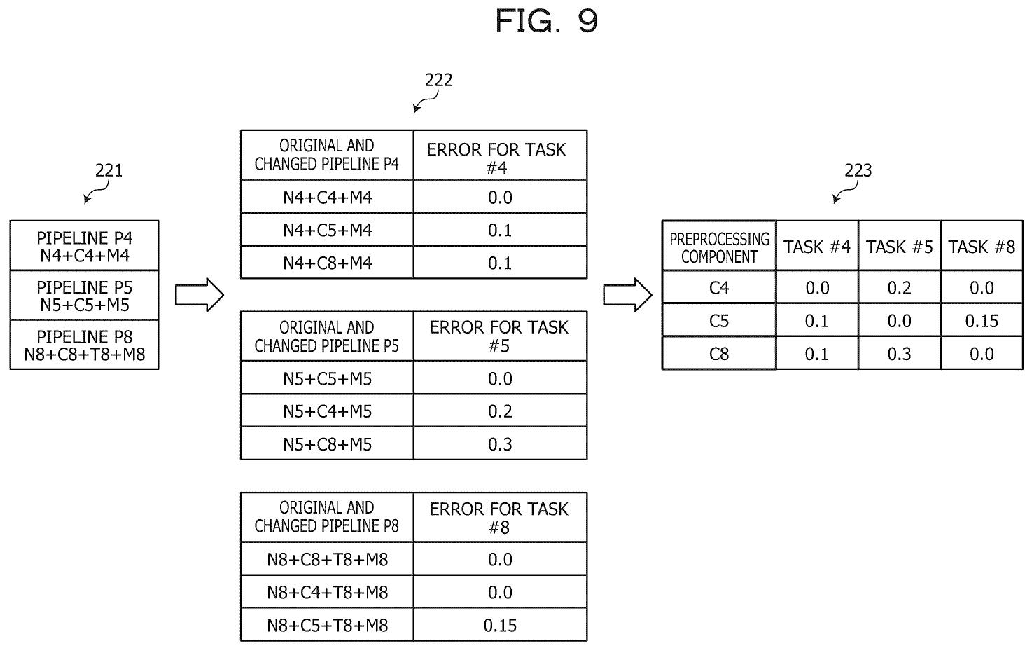

FIG. 9 is a diagram illustrating an example of a method for generating a default preprocessing component by the information processing apparatus according to the second embodiment. Next, an example of a method for generating the default preprocessing component by the information processing apparatus 1 according to the present embodiment will be described with reference to FIG. 9.

For example, a case where a default preprocessing component of the preprocessing component for the category is determined with the category as a target variable type in a case where there are the suitable pipelines P1 to P8 for the tasks #1 to #8 illustrated in Table 211 in FIG. 3 will be described.

In this case, the default preprocess generation unit 102 extracts the preprocessing components C4, C5, and C8 as preprocessing components for the category included in the pipelines P1 to P8. Next, the default preprocess generation unit 102 extracts the pipelines P4, P5, and P8 including the extracted preprocessing components C4, C5, and C8 as illustrated in Table 221, as pipelines including the preprocessing components for the category.

Next, the default preprocess generation unit 102 calculates an error of the pipeline P4. Next, the default preprocess generation unit 102 changes the preprocessing component C4 of the pipeline P4 to the preprocessing component C5 and causes the execution unit 101 to execute the task #4 to acquire an execution result. Then, the default preprocess generation unit 102 calculates an error when the preprocessing component C4 of the pipeline P4 is changed to the preprocessing component C5. In addition, the default preprocess generation unit 102 changes the preprocessing component C4 of the pipeline P4 to the preprocessing component C8 and causes the execution unit 101 to execute the task #4 to acquire an execution result. Then, the default preprocess generation unit 102 calculates an error when the preprocessing component C4 of the pipeline P4 is changed to the preprocessing component C8. The default preprocess generation unit 102 similarly replaces the preprocess for the pipelines P5 and P8 and calculates each error when replaced. This ensures that the default preprocess generation unit 102 calculates, for the pipelines P4, P5, and P8, its individual errors when the preprocessing components for the category are replaced, as illustrated in Table 222.

Table 223 is a table summarizing errors for each task in a case of replacement for each preprocessing component. As illustrated in Table 223, the maximum value of degradation of prediction accuracy, which is the amount of increase in error, is 0.2 for the preprocessing component C4, 0.15 for the preprocessing component C5, and 0.3 for the preprocessing component C8. Thus, the default preprocess generation unit 102 assigns the preprocessing component C5 having the smallest maximum value of degradation of prediction accuracy, as the default preprocessing component for the category.

In addition, in a case where the preprocessing component having a smallest sum of degradation of prediction accuracy is assigned as the default preprocessing component, the default preprocess generation unit 102 determines the default preprocessing component as follows. The sum of degradation of prediction accuracy is 0.2 for the preprocessing component C4, 0.25 for the preprocessing component C5, and 0.4 for the preprocessing component C8. Thus, the default preprocess generation unit 102 assigns the preprocessing component C4 having the smallest sum of degradation of prediction accuracy, as the default preprocessing component for the category.

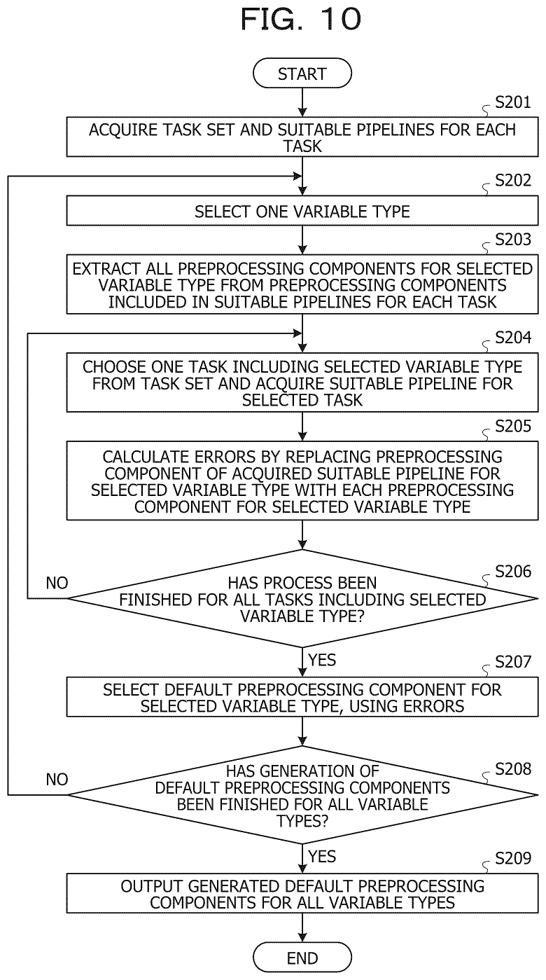

FIG. 10 is a flowchart of a default preprocessing component generation process by the information processing apparatus according to the second embodiment. Each process illustrated in the flowchart in FIG. 10 corresponds to an example of the process executed in step S3 in FIG. 7. Next, a flow of the default preprocessing component generation process by the information processing apparatus 1 according to the present embodiment will be described with reference to FIG. 10.

The default preprocess generation unit 102 acquires the task set and the suitable pipelines for each task from the execution unit 101 (step S201).

The default preprocess generation unit 102 selects one variable type from among variable types used in each task (step S202).

Next, the default preprocess generation unit 102 extracts all preprocessing components for the selected variable type from among the preprocessing components included in the suitable pipelines for each task (step S203).

Next, the default preprocess generation unit 102 selects one task including the selected variable type from the task set and acquires a suitable pipeline for the selected task from among the suitable pipelines for each task (step S204).

Next, the default preprocess generation unit 102 calculates errors by replacing the preprocessing component of the acquired suitable pipeline for the selected variable type with each preprocessing component for the selected variable type (step S205).

Next, the default preprocess generation unit 102 verifies whether or not the error calculation process when the preprocessing component is replaced for all the tasks including the selected variable type has been finished (step S206). In a case where a task for which the error calculation process has not been performed remains (step S206: No), the default preprocess generation unit 102 returns to step S204.

On the other hand, in a case where the error calculation process has been finished for all the tasks including the selected variable type (step S206: Yes), the default preprocess generation unit 102 selects a default preprocessing component for the selected variable type, using the errors (step S207). For example, the default preprocess generation unit 102 assigns, as a default preprocessing component, a preprocessing component having the smallest maximum value of degradation of prediction accuracy corresponding to the amount of increase in error.

Next, the default preprocess generation unit 102 verifies whether or not generation of default preprocessing components has been finished for all the variable types (step S208). In a case where a variable type for which the default preprocessing component has not been generated remains (step S208: No), the default preprocess generation unit 102 returns to step S202.

Meanwhile, in a case where generation of the default preprocessing components has been finished for all the variable types (step S208: Yes), the default preprocess generation unit 102 outputs all the generated default preprocessing components to the pipeline set generation unit 103 (step S209).

As described above, the information processing apparatus according to the present embodiment determines the default preprocessing component according to degradation of prediction accuracy represented by the amount of increase in error. By assigning, as a default preprocessing component, a preprocessing component having smaller degradation of prediction accuracy even after the preprocessing component is replaced, degradation of prediction accuracy may be reduced in more tasks, and robustness may be improved. For example, in a case where there are many varieties of preprocessing components for the same variable type, there is a possibility that differences in appearance frequencies between the respective varieties may be small. Therefore, as in the information processing apparatus according to the present embodiment, it may be effective for improving robustness to determine the default preprocessing component according to degradation of prediction accuracy. For example, the case where there are many varieties of preprocessing components is a case where the number of varieties is larger than half of the total number of tasks, or the like.

In addition, in each of the above embodiments, the information processing apparatus determines the default preprocessing component from the appearance frequency of each preprocessing component or the magnitude of degradation of prediction accuracy. However, the default preprocessing component may be approximately defined if robustness can be sacrificed to some extent. For example, the information processing apparatus may predefine that, for example, OneHotEncoder is used as a default preprocessing component for the category, and CountVectorizer is used as a default preprocessing component for the text. Alternatively, the information processing apparatus may randomly select the default preprocessing component from among all the preprocessing components for the target variable type among the preprocessing components included in the suitable pipelines for each task.

### (Hardware Configuration)

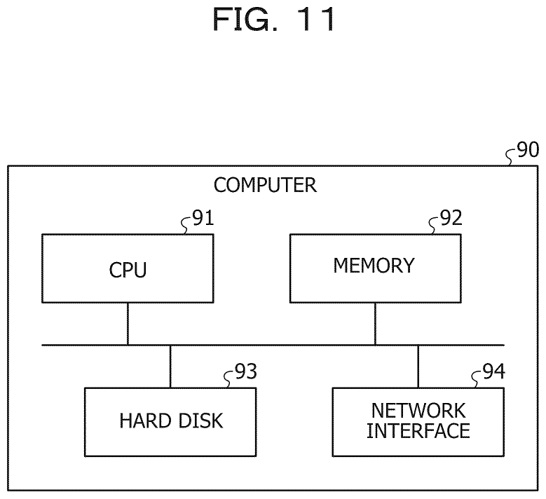

FIG. 11 is a hardware configuration diagram of a computer. The information processing apparatus 1 can be implemented by a computer 90 illustrated in FIG. 11. Next, an example of a hardware configuration of the information processing apparatus 1 will be described with reference to FIG. 11.

As illustrated in FIG. 11, the computer 90 includes, for example, a central processing unit (CPU) 91, a memory 92, a hard disk 93, and a network interface 94. The CPU 91 is coupled to the memory 92, the hard disk 93, and the network interface 94 via a bus.

The network interface 94 is an interface for communication between the computer 90 and an external apparatus. The network interface 94 relays, for example, communication between the user terminal 2 and the CPU 91. The network interface 94 implements the functions of the reception unit 11 and the output unit 12.

The hard disk 93 is an auxiliary storage device. The hard disk 93 stores various programs including a program for implementing the functions of the control unit 10 including the execution unit 101, the default preprocess generation unit 102, and the pipeline set generation unit 103 depicted in FIG. 1.

The memory 92 is a main storage device. For example, a dynamic random access memory (DRAM) can be used as the memory 92.

The CPU 91 reads various programs from the hard disk 93 and loads the read programs into the memory 92 to execute the loaded programs. This ensures that the CPU 91 implements the functions of the control unit 10 including the execution unit 101, the default preprocess generation unit 102, and the pipeline set generation unit 103 depicted in FIG. 1.

Here, a graphics processing unit (GPU) may be used instead of the CPU 91. In addition, the functions of the control unit 10 may be implemented by a plurality of CPUs 91 or a combination of the CPU 91 and the GPU in cooperation with each other.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a pipeline set generation program for causing a computer to execute a process comprising:
acquiring a first pipeline set of which each of pipelines includes a machine learning model, based on a plurality of tasks;
generating a second pipeline set by adding specified components that correspond to each class of variables included in data of the plurality of tasks to each of the pipelines included in the first pipeline set; and
acquiring evaluation values for each of the pipelines included in the second pipeline set, by executing the second pipeline set on the plurality of tasks; and
generating a third pipeline set by selecting a plurality of the pipelines from the second pipeline set, based on the evaluation values.

2. The non-transitory computer-readable recording medium according to claim 1, for further causing the computer to execute the process comprising
selecting the specified components, based on components included in the first pipeline set.

3. The non-transitory computer-readable recording medium according to claim 2, wherein
the selecting the specified components includes selecting, for specified pipelines included in the first pipeline set, the components that are not included in the specified pipelines among the components included in the first pipeline set, as the specified components for the specified pipelines.

4. The non-transitory computer-readable recording medium according to claim 3, wherein
when, for a specified class of the variables, there is a plurality of varieties of the components not included in the specified pipelines among the components included in the first pipeline set, the specified components that correspond to the specified class of the variables are selected based on an appearance frequency of each of the varieties in the first pipeline set.

5. The non-transitory computer-readable recording medium according to claim 3, wherein
when, for a specified class of the variables, there is a plurality of varieties of the components not included in the specified pipelines among the components included in the first pipeline set, the specified components that correspond to the specified class of the variables are selected based on degradation of prediction accuracy by the machine learning model of each of the pipelines included in the first pipeline set when the components of the different varieties are replaced in the first pipeline set.

6. The non-transitory computer-readable recording medium according to claim 1, wherein the acquiring the evaluation values includes acquiring differences between prediction accuracy of a reference pipeline and the prediction accuracy of each of the pipelines included in the second pipeline set, as the evaluation values for each task of the plurality of tasks.

7. A pipeline set generation method for causing a computer to execute a process comprising:
acquiring a first pipeline set of which each of pipelines includes a machine learning model, based on a plurality of tasks;
generating a second pipeline set by adding specified components that correspond to each class of variables included in data of the plurality of tasks to each of the pipelines included in the first pipeline set; and
acquiring evaluation values for each of the pipelines included in the second pipeline set, by executing the second pipeline set on the plurality of tasks; and
generating a third pipeline set by selecting a plurality of the pipelines from the second pipeline set, based on the evaluation values.

8. An information processing apparatus comprising:
a memory; and
a processor coupled to the memory and configured to:
acquire a first pipeline set of which each of pipelines includes a machine learning model, based on a plurality of tasks;
generate a second pipeline set by adding specified components that correspond to each class of variables included in data of the plurality of tasks to each of the pipelines included in the first pipeline set; and
acquire evaluation values for each of the pipelines included in the second pipeline set, by executing the second pipeline set on the plurality of tasks; and
generate a third pipeline set by selecting a plurality of the pipelines from the second pipeline set, based on the evaluation values.
